(19) United States
(12) Patent Application Publication
(10) Pub. No.: US 2026/0302108 A1
(43) Pub. Date: Oct. 1, 2026

(54) MEDIUM OR HIGH VOLTAGE CIRCUIT BREAKER

(71) Applicant: GE Vernova Infrastructure Technology LLC, Greenville, SC (US)

(72) Inventors: Maxime TENET, Villeurbanne (FR); David BERARD, Villeurbanne (FR); Cedric DELHOMME, Villeurbanne (FR); Antoine PERRET, Villeurbanne (FR); Bernhard SPICHIGER, Oberentfelden (CH)

(21) Appl. No.: 19/560,287

(22) Filed: Mar. 9, 2026

(30) Foreign Application Priority Data
Mar. 27, 2025 (EP) 25166691.3

(51) Int. Cl. H01H 33/70; H01H 33/02

(52) U.S. Cl. CPC H01H 33/7015; H01H 33/02

(57) ABSTRACT

A medium-or high-voltage circuit breaker including a first electric arcing contact and a second electric arcing contact that are axially movable relative to each other between an open position, where the arcing contacts are separated, and a closed position, where the arcing contacts are in contact. The circuit breaker includes an auxiliary nozzle made of a fluorocarbon polymer or of polyethylene, polyamide, polyimide, polyketone, polyacetal, polysulfone, polysulfur, which is connected to a support member via a threaded connection. To prevent loosening caused by operational vibrations or shockwaves during arcing events, the threaded connection is equipped with an anti-loosening mechanism. Various embodiments of the anti-loosening means are disclosed. These mechanisms ensure that the auxiliary nozzle remains securely attached to the support member in a screw-in position, while allowing for easy assembly.

### TECHNICAL FIELD

The present invention relates to medium-or high-voltage circuit breakers, including “dead tank”, “metallic enclosed”, “live tank” and “elf-blast” types. More specifically, the invention pertains to an auxiliary nozzle connected to a seat member of a first electric arcing contact, which is designed as a contact socket. The seat member can be called support member in this context.

### BACKGROUND

CN 206401229 U discloses an improved moving contact structure for the arc extinguishing chamber of a 40.5 kV sulfur hexafluoride (SF₆) circuit breaker. The disclosure focuses on optimizing the structural configuration of the moving contact to enhance arc extinguishing performance, improve operational reliability, and increase device longevity.

CN 220710986 U discloses a gas-insulated switchgear (GIS) that utilizes environmentally friendly insulating gases as alternatives to sulfur hexafluoride (SF₆), addressing environmental concerns associated with the greenhouse gas. The GIS incorporates a modular design with auxiliary extension units to facilitate system expansion and maintenance.

U.S. Pat. No. 11,462,377 B2 discloses a circuit breaker with axially movable arcing contacts operable between an open position, where the contacts are separated, and a closed position, where the contacts are in contact. The circuit breaker features an arc blast nozzle with upstream and downstream end portions relative to the flow of arc control gas. The nozzle includes a fluorocarbon polymer auxiliary nozzle, such as one made of polytetrafluoroethylene (PTFE), providing high mechanical and thermal performance. Additionally, the auxiliary nozzle can be made of polyethylene, polyamide, polyimide, polyketone, polyacetal, polysulfone, polysulfur.

However, connecting the dielectric auxiliary nozzle to the arcing contact support has been challenging. Prior approaches, such as snap-fit connections using PTFE auxiliary nozzles with segmented cantilever rings, exhibit mechanical weaknesses under high tensile forces, particularly during arc events. These weaknesses compromise the reliability and durability of the connection.

### SUMMARY

It is an objective of the present invention to provide an improved connection between the dielectric auxiliary nozzle and the arcing contact support. This objective is achieved by the medium-or high-voltage circuit breaker as defined in claim 1.

The inventive medium-or high-voltage circuit breaker comprises a first electric arcing contact and a second electric arcing contact that are axially movable relative to each other. The circuit breaker operates between an open position, in which the arcing contacts are separated, and a closed position, in which the arcing contacts are in contact. The first electric arcing contact includes a contact opening on a first side facing the second electric arcing contact and is configured to receive the second electric arcing contact within the contact opening in the closed position.

The first electric arcing contact is mounted in a support member on a second side facing away from the second electric arcing contact and in a (dielectric) auxiliary nozzle on the first side. The auxiliary nozzle includes an auxiliary nozzle opening aligned with the contact opening of the first electric arcing contact and is made of a fluorocarbon polymer. Additionally, the auxiliary nozzle can be made of polyethylene, polyamide, polyimide, polyketone, polyacetal, polysulfone, polysulfur.

A key aspect of the present invention is the threaded connection between the support member and the auxiliary nozzle. Other connections, such as clip connections, which often rely on cantilevered segments or snap-fit mechanisms to secure components, such as auxiliary nozzles to their supports, present significant drawbacks under operational conditions in medium-or high-voltage circuit breakers. A primary limitation of clip connections is their susceptibility to mechanical failure under high tensile forces, such as those generated during arcing events or by vibrations and shockwaves. The cantilevered segments in clip designs are inherently weak points, prone to deformation or breakage when subjected to such stresses. This compromises the reliability and durability of the connection, leading to potential dislodgment of the dielectric auxiliary nozzle. In contrast, the threaded connection provided in the present invention distributes forces evenly along the thread engagement rather than concentrating them on specific points, as in clip designs. This makes the connection more robust and resistant to mechanical stresses.

The threaded connection further incorporates an anti-loosening mechanism configured to prevent the auxiliary nozzle from moving relative to the support member in a screw-out direction. The fluorocarbon polymer material of the auxiliary nozzle exhibits non-stick and friction-reducing properties, which are beneficial for mechanical performance but also increase the risk of loosening during operation. During arcing events, shockwaves generated by the arcs and the resulting arc-extinguishing gases can transfer to the support member and auxiliary nozzle. These forces, combined with the friction-reducing nature of the fluorocarbon polymer, may cause the threaded connection to loosen over time. The anti-loosening mechanism prevents such movement, ensuring the auxiliary nozzle remains securely attached to the support member, even under high mechanical stress.

A medium-or high-voltage circuit breaker is an electrical switching device designed to interrupt the flow of electrical current in a circuit, either under normal operating conditions or during fault conditions such as short circuits or overloads. It is specifically engineered to operate in systems with voltage ratings typically categorized as:
Medium Voltage (MV): Operating within the range of 1 kV to 36 kV, commonly used in industrial facilities, distribution networks, and infrastructure systems; or
High Voltage (HV): Operating at voltages above 36 kV, typically used in transmission networks and substations for large-scale power distribution.

Medium- and high-voltage circuit breakers are critical for maintaining electrical safety, ensuring system stability, and protecting equipment from damage. They use advanced arc-quenching mechanisms such as gas (e.g., SF₆ or eco-friendly alternatives), vacuum, or air blast to extinguish the electric arc that forms during current interruption.

These breakers are further classified based on their design and functionality, including types like “dead tank”, “live tank”, “puffer”, and “self-blast” circuit breakers.

The auxiliary nozzle can be made of various fluorocarbon polymers, such as polytetrafluoroethylene (PTFE), chlorotrifluoroethylene (CTFE), perfluorocycloalkene (PFCA), ethylene vinyl fluoride (VF1), vinylidene fluoride (VDF or VF2), hexafluoropropylene (HFP), perfluoropropylvinyl ether (PPVE), or perfluoromethylvinyl ether (PMVE). The support member is typically made of a metal, such as aluminum, steel, copper, or other suitable materials.

Preferably, the auxiliary nozzle comprises an auxiliary nozzle thread, and the support member comprises a support thread, wherein the auxiliary nozzle thread and the support thread are engageable with each other.

In particular, the anti-loosening means is configured to be effective only when the auxiliary nozzle and the support member are in a screwed-in end position, wherein the auxiliary nozzle thread has reached the last turns of the support thread or vice versa. The anti-loosening means locks the auxiliary nozzle against movement in a screw-out direction while allowing relative movement in a screw-in direction.

Particularly, the anti-loosening means prevents the auxiliary nozzle from moving relative to the support member in the screw-out direction when the auxiliary nozzle and the support member are in a screwed-in end position.

Preferably, the support thread is an internal thread, and the auxiliary nozzle thread is an external thread, with both threads adapted to engage with each other.

In a first embodiment, the anti-loosening means comprises an elastically compressible annular member arranged between the support member and the auxiliary nozzle. The annular member is compressed when the auxiliary nozzle thread reaches the last turns of the support thread or vice versa. The compressed annular member applies an axial force to the auxiliary nozzle, pressing the threads against each other. This increased friction counteracts unscrewing movements caused by vibrations, shockwaves, or other external forces. The compressible annular member is a simple yet effective measure for preventing thread loosening.

Preferably, a first end surface is formed on a radial surface of the support member facing the auxiliary nozzle, and a second end surface is formed on a radial surface of the auxiliary nozzle facing the support member. The compressible annular member is compressed between the first and second end surfaces when the auxiliary nozzle and the support member are in a screwed-in end position.

In a second embodiment, the anti-loosening means comprises at least one spring-loaded pin and a contour arranged such that the pin and the contour move relative to each other when the auxiliary nozzle rotates in a screw-in direction. The pin is spring-loaded against the contour when the auxiliary nozzle thread reaches the last turns of the support thread or vice versa. Preferably, multiple pins are arranged concentrically to the axis of the support member and positioned in the axial direction. The pin is preferably located on the support member, and the contour is formed on a surface of the auxiliary nozzle facing the pin.

The contour preferably comprises a plurality of contour pockets, each having a first and a second slope. The first slope is particularly configured to lock the pin when it is arranged in one of the pockets, preventing movement of the auxiliary nozzle in the screw-out direction. The first slope is steeper than the second slope, allowing the pin to slide over the second slope when the auxiliary nozzle is rotated in the screw-in direction. Once the pin is locked in a pocket, the auxiliary nozzle is securely retained in the screwed-in position.

In a further embodiment, the anti-loosening means comprises a plurality of ratchets formed on the auxiliary nozzle at the tip of the auxiliary nozzle thread, protruding radially outward, and at least one recess formed on the support member at the base of the support thread. The ratchets are configured to snap into the recess when the auxiliary nozzle thread and the support thread reach their end positions. Preferably, the auxiliary nozzle and the ratchets are monolithically formed as a single piece.

Preferably, the ratchets are elastic barb members with an inclined leading edge and a locking edge. The leading-edge slides over the recess edges in the screw-in direction, while the locking edge engages with the recess edge to prevent movement in the screw-out direction.

In another embodiment, the anti-loosening means comprises a radially extending annular protrusion formed on the support member and an annular brim with an adjacent annular groove formed on the auxiliary nozzle. The annular brim and protrusion include inclined guiding surfaces arranged in the axial direction. The annular brim passes over the protrusion during screwing, and the protrusion snaps into the annular groove when the threads reach their end positions.

Preferably, a plurality of axially extending notches is formed in the annular brim to facilitate deformation during engagement with the annular protrusion.

The annular brim and groove may be arranged at the tip of the auxiliary nozzle thread, with the annular protrusion at the base of the support thread, or vice versa.

To enhance the functionality of the annular brim, a plurality of axially extending notches is distributed circumferentially along the annular brim. These notches divide the annular brim into multiple segments, allowing it to flex radially inward when the auxiliary nozzle is screwed into the support member in the screw-in direction. This configuration reduces the force required to push the annular brim over the annular protrusion while maintaining its ability to snap securely into the annular groove once the protrusion passes over the brim. The circumferential distribution of the notches ensures uniform flexibility and consistent mechanical performance around the entire circumference of the annular brim.

The guiding surfaces of the annular protrusion and the annular brim are configured to optimize engagement and locking performance. The guide surfaces have an angle of inclination relative to the axial direction. The angle of the guide surface can be in a range of 20° to 70°, preferably in a range of 30° and 60°, more preferably in a range of 40° and 50°, in particular at least substantially 45°.

On the opposite side of the guiding surfaces, the surfaces feature a steeper locking angle.

This locking angle is configured to resist disengagement in the screw-out direction, providing a robust locking mechanism that prevents unintentional loosening of the auxiliary nozzle from the support member. The combination of the inclination angle and the steeper locking angle ensures that the anti-loosening means remains effective even under high mechanical stresses, such as during arcing events, thereby maintaining the integrity of the connection between the auxiliary nozzle and the support member.

### BRIEF DESCRIPTION OF THE DRAWINGS

Features of the various embodiments described herein may be combined with one another where appropriate, provided such combinations are not mutually exclusive. Further details and features may be found in the drawings, the description, and the claims. The accompanying drawings are as follows:

FIG. 1: Example of a circuit breaker in a longitudinal sectional view;

FIG. 2: a first example of the anti-loosening means in a longitudinal-sectional view;

FIGS. 3 to 6: a second example of the anti-loosening means in a longitudinal-sectional view and detailed views;

FIGS. 7 and 8: a third example of the anti-loosening means in a longitudinal-sectional and a cross-sectional view;

FIGS. 9 to 11: a fourth example of the anti-loosening means in a longitudinal-sectional view and detailed views; and

FIGS. 12 to 14: a fifth example of the anti-loosening means in a longitudinal-sectional view and detailed views.

### DETAILED DESCRIPTION

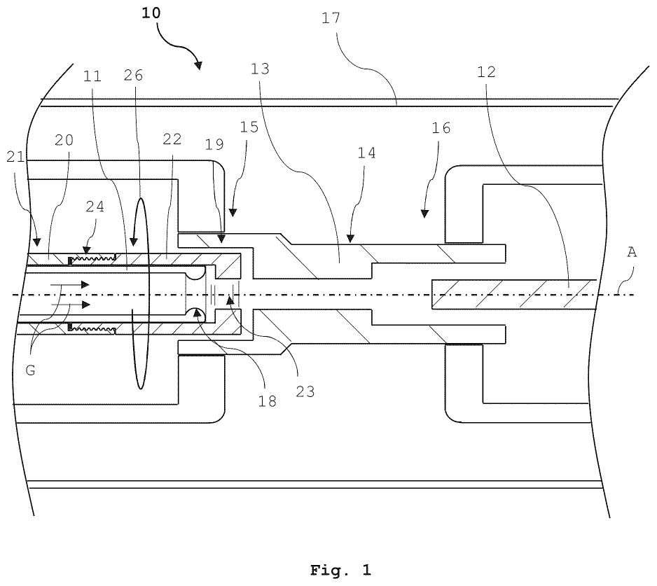

FIG. 1 illustrates an example of a medium-or high-voltage circuit breaker 10. The embodiment shown in FIG. 1 is merely exemplary; the present invention contemplates all embodiments of medium-or high-voltage circuit breakers, particularly those in which an auxiliary nozzle is connected to the support member of an electrode via a threaded connection.

The circuit breaker 10 includes a first electric arcing contact 11 and a second electric arcing contact 12, which are axially movable along an axis A relative to each other. The circuit breaker 10 operates between an open position, where the electric arcing contacts 11 and 12 are separated, and a closed position, where the electric arcing contacts 11 and 12 are in contact.

As shown in FIG. 1, the circuit breaker 10 further includes an arc blast nozzle 13 positioned between the first arcing contact 11 and the second arcing contact 12. The arc blast nozzle 13 comprises a throat-forming middle portion 14, an upstream end portion 15, and a downstream end portion 16. The terms “upstream” and “downstream” refer to the flow direction of the arc control gas.

The arc control gas can be any type of arc-extinguishing gas. The arc control gas may comprise sulfur hexafluoride (SF₆). The arc control gas may further comprise carbon dioxide (CO₂). Alternatively, the arc control gas may be a mixture containing heptafluoroisobutyronitrile, carbon dioxide (CO₂), and optionally oxygen. For example, it can be a gas, which consists of 2 to 15 mol % of heptafluoroisobutyronitrile, 60 to 98 mol % of carbon dioxide, and 0 to 25 mol % of oxygen.

The first arcing contact 11, second arcing contact 12, and arc blast nozzle 13 are encapsulated within an arc extinguishing chamber 17.

The first arcing contact 11 features a contact opening 18 on a first side 19 facing the second arcing contact 12. The first arcing contact 11 is configured to receive the second arcing contact 12 through the contact opening 18 when the circuit breaker 10 is in the closed position.

The first arcing contact 11 is arranged within a support member 20 on a second side 21, which faces away from the second arcing contact 12. On the first side 19, the first arcing contact 11 is disposed within an auxiliary nozzle 22. The auxiliary nozzle 22 includes an auxiliary nozzle opening 23 that aligns with the contact opening 18. The auxiliary nozzle 22 is made of a fluorocarbon polymer, such as polytetrafluoroethylene (PTFE).

The support member 20 and the auxiliary nozzle 22 are connected via a threaded connection 24 that includes an anti-loosening means 25. The anti-loosening means 25 is configured to prevent the auxiliary nozzle 22 from moving relative to the support member 20 in a screw-out direction 26.

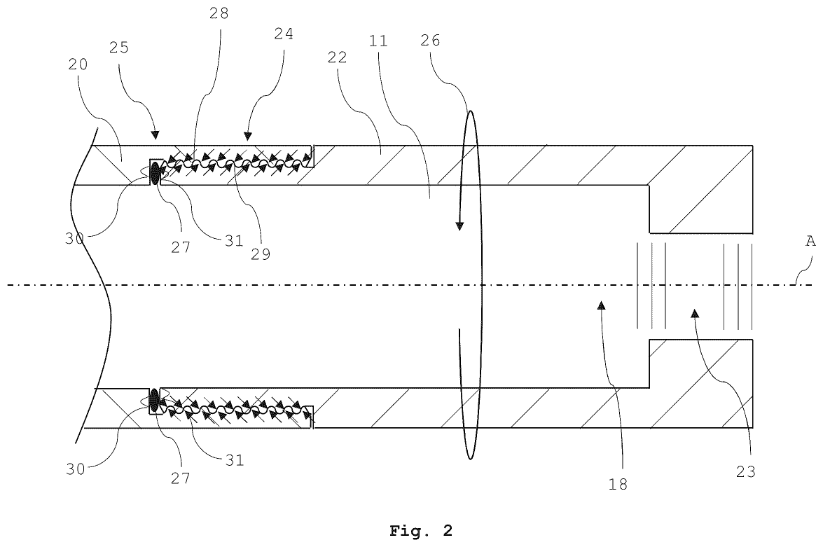

FIG. 2 provides a detailed longitudinal sectional view of the first embodiment of the anti-loosening means 25. In this embodiment, the anti-loosening means 25 includes an elastically compressible annular member 27 positioned between the support member 20 and the auxiliary nozzle 22.

As shown in FIG. 2, the support member 20 includes a support thread 28, and the auxiliary nozzle 22 includes an auxiliary nozzle thread 29. Both threads have a plurality of turns. In this embodiment, the support thread 28 is an internal thread, and the auxiliary nozzle thread 29 is an external thread, with both threads adapted to engage with each other.

In the simplest example, the compressible annular member may be an O-ring. Alternatively, the compressible annular member 27 can be a wave spring, a helical compression spring ring, or the like.

In FIG. 2, the auxiliary nozzle 22 is shown in a screwed-in end position relative to the support member 20. In this position, the compressible annular member 27 is in a compressed state and applies an axial force to the auxiliary nozzle 22. This force presses the threads 28 and 29 against each other, as indicated by small arrows in the figure. The increased friction between the auxiliary nozzle thread 29 and the support thread 28 prevents the auxiliary nozzle 22 from moving in the screw-out direction 26.

The compressible annular member 27 is positioned between a first end surface 30, formed on a radial surface of the support member 20 facing the auxiliary nozzle 22, and a second end surface 31, formed on a radial surface of the auxiliary nozzle 22 facing the support member 20.

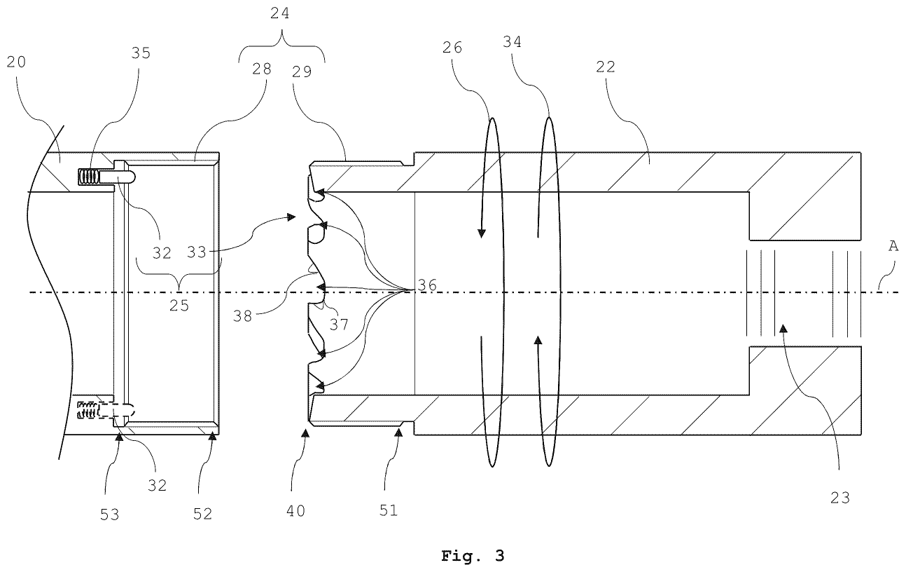

FIG. 3 illustrates a second embodiment of the anti-loosening means 25. In this embodiment, the anti-loosening means 25 include at least one pin 32 and a contour 33 arranged such that the pin 32 and the contour 33 move relative to each other when the auxiliary nozzle 22 rotates in a screw-in direction 34 around the axis A. The pin 32 is spring-loaded via a spring member 35 against the contour 33 when the auxiliary nozzle thread 29 reaches the last turns of the support thread 28, or vice versa. In FIG. 3, a second spring-loaded pin 32 and its corresponding contour 33 are shown in dashed lines. Preferably, a plurality of spring-loaded pins 32 are used to increase the angular precision of the anti-loosening means 25.

The contour 33 comprises a plurality of contour pockets 36 arranged on a radial surface facing the pin 32. Each contour pocket 36 includes a first slope 37 and a second slope 38. The first slope 37 is steeper than the second slope 38. This configuration allows the first slope 37 to lock the pin 32 when the pin is engaged with the contour pocket 36, thereby preventing the auxiliary nozzle 22 from moving relative to the support member 20 in the screw-out direction 26 around the axis A.

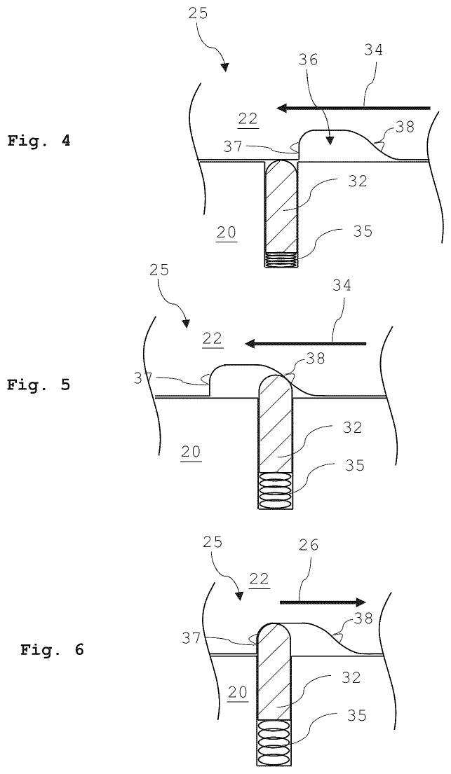

FIGS. 4 to 6 provide detailed views of the anti-loosening means 25, illustrating the auxiliary nozzle 22 in various angular positions relative to the support member 20.

In FIG. 4, the spring member 35 is shown in a compressed state as the pin 32 has not yet reached a contour pocket 36 of the contour 33. In this state, the auxiliary nozzle 22 is being rotated in the screw-in direction 34.

FIG. 5 shows the auxiliary nozzle 22 in a further screwed-in position in the screw-in direction 34. In this position, the pin 32 is about to enter a contour pocket 36 and is in contact with the second slope 38. Since the second slope 38 is less steep than the first slope 37, the pin 32 can slide along it, allowing the auxiliary nozzle 22 to be rotated further in the screw-in direction 34 without obstruction.

FIG. 6 depicts the auxiliary nozzle 22 being rotated in the screw-out direction 26. In this state, the pin 32 is engaged with the first slope 37 of the contour pocket 36. Due to the steepness of the first slope 37, the auxiliary nozzle 22 cannot be rotated further in the screw-out direction 26, effectively locking it in place.

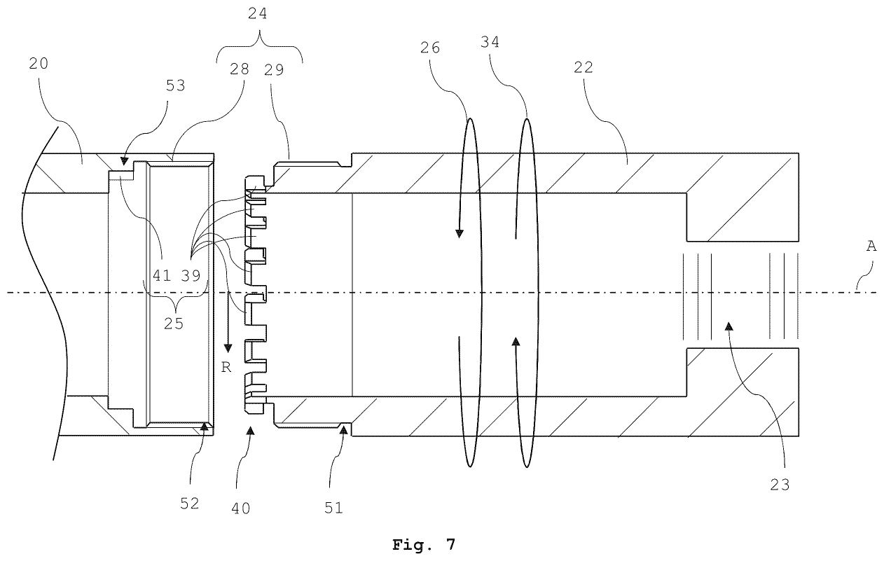

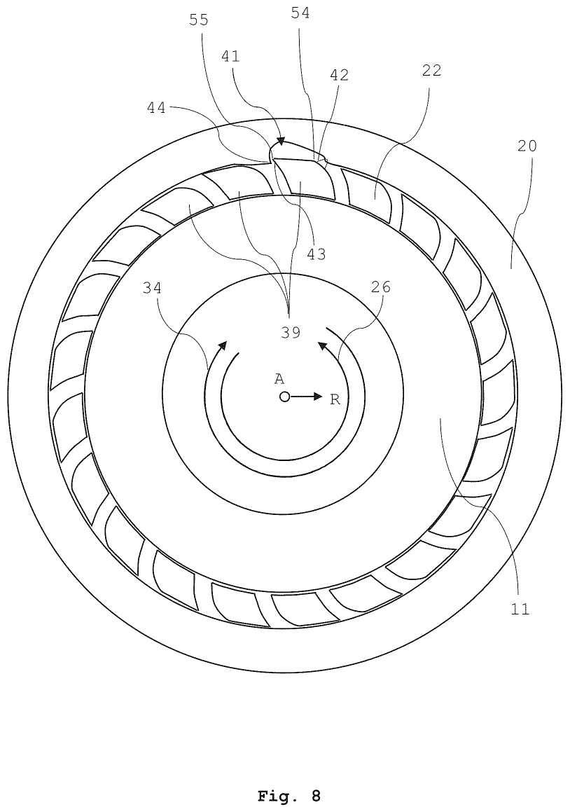

FIGS. 7 and 8 illustrate a third example of the inventive anti-loosening means 25. In this embodiment, the anti-loosening means 25 includes a plurality of ratchets 39 formed on the auxiliary nozzle 22 at the tip 40 of the auxiliary nozzle thread 29, facing the support member 20. The ratchets 39 protrude radially outward in a radial direction R. The anti-loosening means 25 further includes at least one recess 41 formed on the support member 20 at the base 53 of the support thread 28. The ratchets 39 and the recess 41 are configured such that the ratchets 39 snap into the recess 41 when the auxiliary nozzle 22 is in a screwed-in end position relative to the support member 20.

The ratchets 39 and the auxiliary nozzle 22 are monolithically formed from PTFE. The ratchets 39 are elastic barbs configured to pass over the edges of the recess 41 in the screw-in direction 34, and to engage securely in the recess 41 after passing the edges. This engagement prevents the auxiliary nozzle 22 from moving relative to the support member 20 in the screw-out direction 26.

FIG. 8 provides a cross-sectional view of the anti-loosening means 25 in the third example. In this embodiment, the ratchets 39 are evenly distributed along the circumference of the auxiliary nozzle 22 around the axis A, with each ratchet 39 positioned at a constant distance from the axis A.

Each ratchet 39 includes a guide surface 42 and a barbed edge 43. The guide surface 42 is configured to slide over the edge 44 of the recess 41 when the auxiliary nozzle 22 is rotated in the screw-in direction 34 around the axis A. The barbed edge 43 follows the guide surface 42 and locks against the edge 44 of the recess 41 once the ratchet 39 is seated in the recess 41.

In FIG. 8, one ratchet 39 is shown engaged with the recess 41, with its barbed edge 43 abutting the edge 44 of the recess 41. This engagement prevents the auxiliary nozzle 22 from moving relative to the support member 20 in the screw-out direction 26. The ratchets 39 are flexible projections with an inclined leading edge 54 and a locking edge 55, the leading edge 54 being configured to slide over the edges of the recess 41 in the screw-in direction 34, and the locking edge 55 being configured to engage securely with the recess 41 to prevent movement of the auxiliary nozzle 22 in the screw-out direction 26.

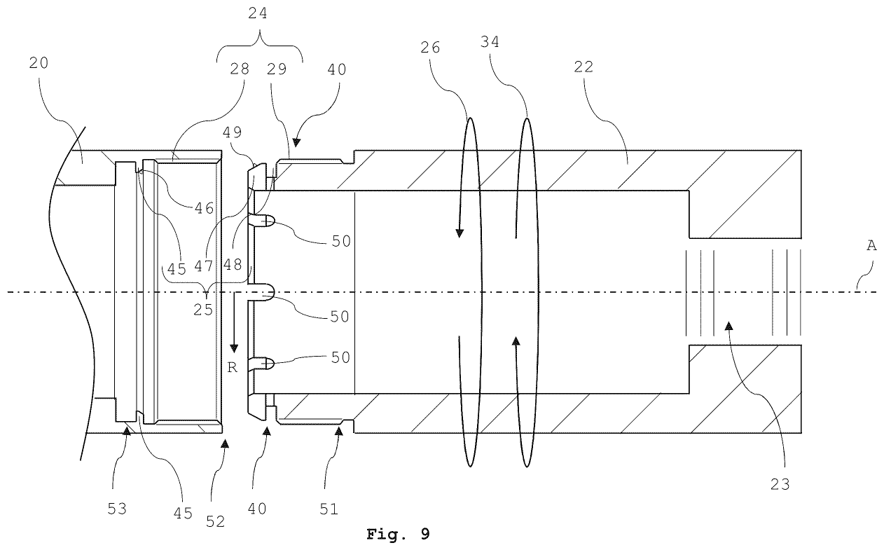

FIGS. 9, 10, and 11 illustrate a fourth example of the anti-loosening means 25. In this embodiment, the anti-loosening means 25 comprises a radially extending annular protrusion 45 formed on the support member 20. The annular protrusion 45 includes a guide surface 46 that faces the auxiliary nozzle 22 and is inclined toward it.

The anti-loosening means 25 further includes an annular brim 47 and an adjacent annular groove 48, both formed on the auxiliary nozzle 22. The annular brim 47 features a guide surface 49 facing the support member 20. The guide surface 49 of the annular brim 47 is also inclined. The guide surfaces 46 and 49 are configured to slide along each other as the auxiliary nozzle 22 is screwed into the support member 20. During this process, the annular brim 47 is pushed radially inward, allowing the annular protrusion 45 to pass over the annular brim 47. Once the annular brim 47 passes the annular protrusion 45, the annular protrusion 45 is trapped in the annular groove 48, locking the auxiliary nozzle 22 in place when moved in the screw-out direction 26.

To facilitate the annular brim 47 being pushed radially inwards, the annular brim 47 is divided into multiple clip-like segments by a plurality of axially extending notches 50. These notches 50 allow the segments of the annular brim 47 to flex radially inward as the annular protrusion 45 passes over it.

FIG. 10 provides a detailed view of the anti-loosening means 25 during the process where the annular brim 47 passes over the annular protrusion 45. The inclination angle α of the guide surface 46 of the annular protrusion 45 and the guide surface 49 of the annular brim 47 is at least substantially 45° relative to the angular axis A. The locking angle β of the surface neighboring the annular brim 47 is at least substantially 90° relative to the angular axis A. Both angles α and β may deviate from the example provided in FIG. 10.

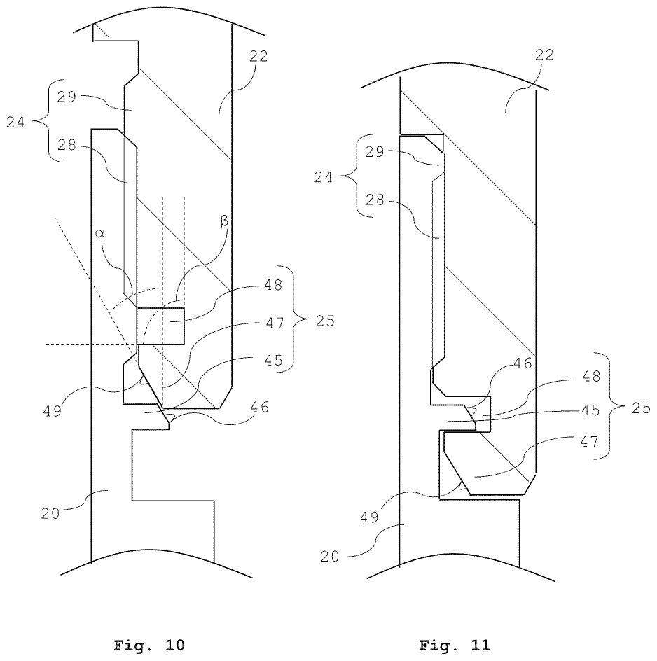

FIG. 11 illustrates the state after the annular protrusion 45 has snapped into the annular groove 48. In this position, the annular protrusion 45, seated in the annular groove 48, prevents the auxiliary nozzle 22 from moving in the screw-out direction 26.

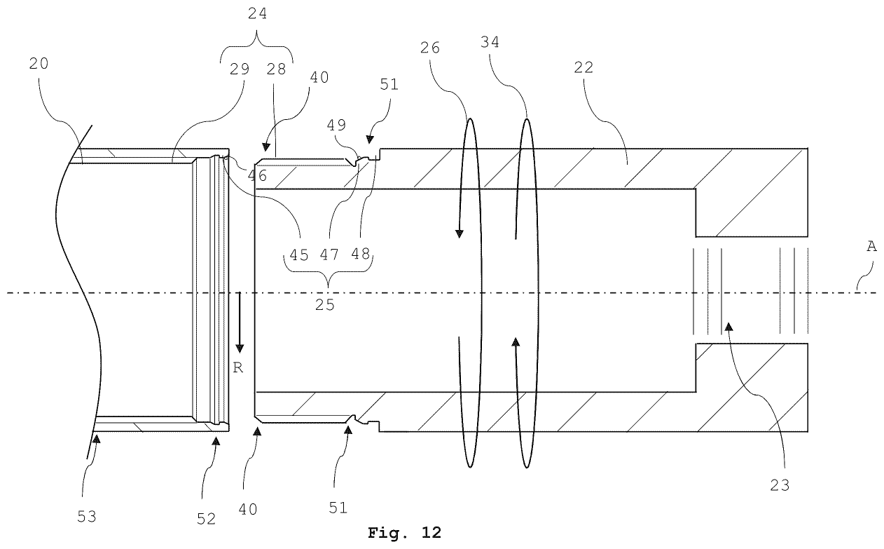

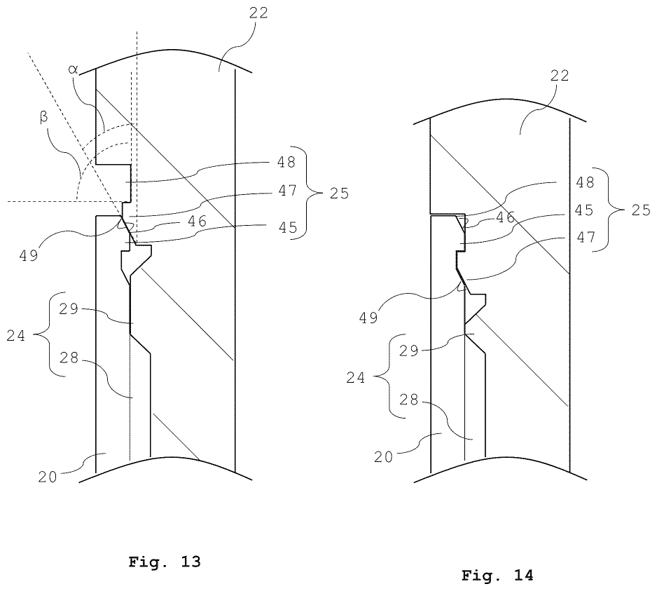

FIGS. 12, 13, and 14 illustrate a fifth example of the inventive anti-loosening means 25.

This example is similar to the fourth example, with a key difference in the arrangement of components. In the fourth example, the annular brim 47 and the annular groove 48 are positioned at the tip of the auxiliary nozzle thread 29, and the annular protrusion 45 is formed at the base 53 of the support thread 28. In contrast, in the fifth example, the annular brim 47 and the annular groove 48 are arranged at the base 51 of the auxiliary nozzle thread 29, while the annular protrusion 45 is formed at the tip 52 of the support thread 28.

The present invention relates to a medium-or high-voltage circuit breaker 10 comprising a first electric arcing contact 11 and a second electric arcing contact 12 that are axially movable relative to each other between an open position, where the arcing contacts 11, 12 are separated, and a closed position, where the arcing contacts are in contact. The circuit breaker 10 includes an auxiliary nozzle 22 made of a fluorocarbon polymer or of polyethylene, polyamide, polyimide, polyketone, polyacetal, polysulfone, polysulfur, which is connected to a support member 20 via a threaded connection 24. To prevent loosening caused by operational vibrations or shockwaves during arcing events, the threaded connection is equipped with an anti-loosening mechanism. Various embodiments of the anti-loosening means 25 are disclosed, including a compressible annular member 27 that increases friction between threads, spring-loaded pins 32 interacting with contour pockets 36, elastic ratchets 39 engaging with recesses 41, and an annular brim 47 cooperating with an annular protrusion 45. These mechanisms ensure that the auxiliary nozzle 22 remains securely attached to the support member 20 in a screw-in position, while allowing for easy assembly. The invention provides a robust, reliable connection between the auxiliary nozzle 22 and the support member 20, enhancing the performance and durability of the circuit breaker 10 under high mechanical and thermal stress conditions.

### REFERENCE SIGNS

10 Medium or high voltage circuit breaker
11 First (electric) arcing contact
12 Second (electric) arcing contact
13 Arc blast nozzle
14 Middle portion
15 End portion (upstream)
16 End portion (downstream)
17 Arc extinguishing chamber
18 Contact opening
19 First side
20 Support member
21 Second side
22 (dielectric) auxiliary nozzle
23 Auxiliary nozzle opening
24 Thread connection
25 Anti-loosening means
26 Screw-out direction
27 Compressible annular member
28 Support thread
29 Auxiliary nozzle thread
30 First end surface
31 Second end surface
32 (spring-loaded) pin
33 Contour
34 Screw-in direction
35 Spring member
36 Contour pocket
37 First slope of the contour pocket
38 Second slope of the contour pocket
39 Ratchet
40 Tip of the auxiliary nozzle thread
41 Recess
42 Guide surface of the ratchet
43 Barbed edge of the ratchet
44 Edge of the recess
45 Annular protrusion
46 Guide surface of the annular protrusion
47 Annular brim
48 Annular groove
49 Guide surface of the annular brim
50 Notch
51 Base of the auxiliary nozzle thread
52 Tip of the support thread
53 Base of the support thread
54 Leading edge
55 Locking edge
A Axial axis
G Stream of arc extinguishing gas
R Radial direction
α inclination angle
β locking angle

We claim:

1. A medium-or high-voltage circuit breaker, comprising:
a first arcing contact and a second arcing contact that are axially movable relative to each other between an open position of the circuit breaker, in which the arcing contacts are separated from each other, and a closed position of the circuit breaker, in which the arcing contacts are in contact with each other,
wherein the first arcing contact includes a contact opening on a first side facing the second arcing contact, the first arcing contact being configured to receive the second arcing contact within the contact opening when the arcing contacts are in the closed position,
wherein the first arcing contact is disposed in a support member on a second side facing away from the second arcing contact and in an auxiliary nozzle on the first side of the first arcing contact,
wherein the auxiliary nozzle comprises an auxiliary nozzle opening aligned with the contact opening and is made of a fluorocarbon polymer,
wherein the support member and the auxiliary nozzle are connected to each other by a threaded connection including an anti-loosening mechanism configured to prevent the auxiliary nozzle from moving relative to the support member in a screw-out direction.

2. The medium-or high-voltage circuit breaker according to claim 1, wherein the auxiliary nozzle comprises an auxiliary nozzle thread and the support member comprises a support thread, the auxiliary nozzle thread and the support thread being engageable with each other.

3. The medium-or high-voltage circuit breaker according to claim 2, wherein the support thread is an internal thread and the auxiliary nozzle thread is an external thread, the threads being adapted to each other.

4. The medium-or high-voltage circuit breaker according to claim 1, wherein the anti-loosening means is effective only when the auxiliary nozzle thread reaches the last turns of the support thread or vice versa.

5. The medium-or high-voltage circuit breaker according to claim 4, wherein the anti-loosening means comprises an elastically compressible annular member arranged between the support member and the auxiliary nozzle, the annular member being compressed when the auxiliary nozzle thread reaches the last turns of the support thread or vice versa.

6. The medium-or high-voltage circuit breaker according to claim 5, wherein the compressed annular member applies an axial force to the auxiliary nozzle, pressing the threads against each other.

7. The medium-or high-voltage circuit breaker according to claim 1, wherein the anti-loosening means comprises:
(a) at least one spring-loaded pin configured to engage a contour on the auxiliary nozzle or the support member, wherein the pin and the contour move relative to each other when the auxiliary nozzle rotates in a screw-in direction; and
(b) a plurality of contour pockets on the contour, each having a first slope configured to lock the pin and prevent movement of the auxiliary nozzle relative to the support member in a screw-out direction.

8. The medium-or high-voltage circuit breaker according to claim 1, wherein the anti-loosening means comprises:
(a) a plurality of ratchets formed on the auxiliary nozzle and protruding radially outward from the tip of the auxiliary nozzle thread; and
(b) at least one recess formed in the support member at the base of the support thread, the ratchets being configured to snap into the recess when the auxiliary nozzle thread and/or the support thread reach their end portions.

9. The medium-or high-voltage circuit breaker according to claim 8, wherein the ratchets are elastic barb members configured to pass the edges of the recess in the screw-in direction and to engage with the recess after passing the edges, thereby preventing the auxiliary nozzle from moving in the screw-out direction.

10. The medium-or high-voltage circuit breaker according to claim 8, wherein the ratchets are flexible projections with an inclined leading edge and a locking edge, the leading edge being configured to slide over the edges of the recess in the screw-in direction, and the locking edge being configured to engage securely with the recess to prevent movement of the auxiliary nozzle in the screw-out direction.

11. The medium-or high-voltage circuit breaker according to claim 1, wherein the anti-loosening means comprises:
(a) a radially extending annular protrusion formed in the support member; and
(b) an annular brim and an adjacent annular groove formed on the auxiliary nozzle,
wherein the annular brim and the annular protrusion have inclined guiding surfaces arranged in the axial direction such that the annular brim passes over the annular protrusion during screwing, and the annular protrusion snaps into the annular groove when the threads reach their end portions.

12. The medium-or high-voltage circuit breaker according to claim 10, wherein a plurality of axially extending notches is formed in the annular brim to facilitate deformation during engagement with the annular protrusion.

13. The medium-or high-voltage circuit breaker according to claim 11, wherein:
(a) the annular brim and the annular groove are located at the tip of the auxiliary nozzle thread, and the annular protrusion is located at the base of the support thread; or
(b) the annular brim and the annular groove are located at the base of the auxiliary nozzle thread, and the annular protrusion is located at the tip of the support thread.

14. The medium-or high-voltage circuit breaker according to claim 1, wherein the notches in the annular brim are distributed circumferentially.

15. The medium-or high-voltage circuit breaker according to claim 10, wherein the inclined guiding surfaces of the annular brim and the annular protrusion are configured with:
(a) an angle of inclination relative to the axial direction optimized to facilitate smooth engagement during screwing in the screw-in direction; and
(b) a steeper locking angle on the opposite side of the guiding surfaces to resist disengagement in the screw-out direction.
